(19) United States
(12) Patent Application Publication
(10) Pub. No.: US 2020/0214522 A1
(43) Pub. Date: Jul. 9, 2020

(54) DIRT SEPARATOR FOR A VACUUM CLEANER

(71) Applicant: Dyson Technology Limited, Wiltshire (GB)

(72) Inventors: Tim John MACLEAN, Bath (GB); Mateusz GUGALA, Gloucester (GB); Jonathan Bartholomew MURPHY, Bristol (GB); Andrew John ISAACS, Gloucester (GB); Charles Howard PERCY-RAINE, Swindon (GB); Gregory William DUSSEK, Gloucester (GB)

(73) Assignee: Dyson Technology Limited, Wiltshire (GB)

(21) Appl. No.: 16/638,034

(22) PCT Filed: Jul. 30, 2018
(86) PCT No.: PCT/GB2018/052163

§ 371 Date: Feb. 10, 2020

(30) Foreign Application Priority Data
Aug. 11, 2017 (GB) 1712933.9
Apr. 30, 2018 (GB) 1807063.1

(51) Int. Cl. A47L 9/12; A47L 9/10; A47L 9/14; A47L 9/16; B01D 45/14; B01D 46/00; B01D 46/10

(52) U.S. Cl. CPC A47L 9/122; A47L 9/102; A47L 9/1409; A47L 9/16; B01D 2279/55; B01D 45/14; B01D 46/0056; B01D 46/106; B01D 2275/30; A47L 9/1675

(57) ABSTRACT

A dirt separator for a vacuum cleaner including a chamber having an inlet through which dirt-laden fluid enters the chamber and an outlet through which cleansed fluid exits the chamber; and a disc located at the outlet, the disc being arranged to rotate about a rotational axis, and including holes running from an upstream face to a downstream face through which the cleansed fluid passes. Each hole has a tapered portion which narrows from an upstream end to a downstream end thereof.

### CROSS-REFERENCE TO RELATED APPLICATIONS

This application is a national stage application under 35 USC 371 of International Application No. PCT/GB2018/052163, filed Jul. 30, 2018, which claims the priority of United Kingdom Application No. 1712933.9, filed Aug. 11, 2017 and United Kingdom Application No. 1807063.1, filed Apr. 30, 2018, the entire contents of each of which are incorporated herein by reference.

### FIELD OF THE DISCLOSURE

The present invention relates to a dirt separator for a vacuum cleaner.

### BACKGROUND OF THE DISCLOSURE

The dirt separator of a vacuum cleaner may comprise a porous bag or a cyclonic separator. However, both types of separator have their disadvantages. For example, the pores of a bag quickly clog with dirt during use, whilst the pressure consumed by a cyclonic separator can be high.

### SUMMARY OF THE DISCLOSURE

According to a first aspect of the present invention there is provided a dirt separator for a vacuum cleaner, the dirt separator comprising a chamber having an inlet through which dirt-laden fluid enters the chamber and an outlet through which cleansed fluid exits the chamber; and a disc located at the outlet, the disc being arranged to rotate about a rotational axis, and comprising holes running from an upstream face to a downstream face through which the cleansed fluid passes, wherein each hole has a tapered portion which narrows from an upstream end to a downstream end thereof.

The dirt-laden fluid entering the chamber contacts the rotating disc, which imparts tangential forces to the fluid. As the dirt-laden fluid moves radially outward, the tangential forces imparted by the disc increase. The fluid is then drawn through the holes in the disc whilst the dirt, owing to its greater inertia, continues to move outwards and collects at the bottom of the chamber.

The dirt separator according to various aspects of the present invention has advantages over conventional separators such as a porous bag or cyclonic separator. For example, the pores of a bag quickly clog with dirt during use. This then reduces the suction that is achieved at the cleaner head. With the dirt separator according to various aspects of the present invention, rotation of the disc helps ensure that the holes in the disc are generally kept clear of dirt. As a result, no significant reduction in suction may be observed during use. The cyclonic separator of a vacuum cleaner typically comprises two or more stages of separation. The first stage often comprises a single larger cyclone chamber for removing coarse dirt, and the second stage comprises a number of smaller cyclone chambers for removing fine dirt. As a result, the overall size of the cyclonic separator can be large. A further difficulty with the cyclonic separator is that it typically requires high fluid speeds in order to achieve high separation efficiencies. Additionally, the fluid moving through the cyclonic separator often follows a relatively long path as it travels from the inlet to the outlet. As a result, the pressure drop associated with the cyclonic separator can be high. With the dirt separator according to various aspects of the present invention, relatively high separation efficiencies can be achieved in a more compact manner. In particular, the dirt separator may comprise a single stage having a single chamber. Furthermore, separation occurs primarily as a result of the angular momentum imparted to the dirt by the rotating disc. As a result, relatively high separation efficiencies may be achieved at relatively low fluid speeds. Additionally, the path taken by the fluid in moving from the inlet to the outlet of the chamber is relatively short. As a result, the pressure drop across the dirt separator may be smaller than that across a cyclonic separator having the same separation efficiency.

The holes having tapered portions may smooth the flow of air through them, in comparison to an arrangement where each hole has a constant cross sectional area or widens from the upstream end to the downstream end. Instead or as well, it may provide a greater opportunity for dirt which enters the hole to be separated rather than passing all the way through, as discussed in more detail later.

The tapered portion may define a taper angle of at least 5 degrees, for instance at least 10 degrees or at least 15 degrees. In some embodiments the tapered portion may define a taper angle of at least 20 degrees or at least 25 degrees.

The tapered portion of each hole may include a chamfer surface positioned at the intersection between the hole and the upstream face of the disc.

The chamfer surface provides a sloped surface of the hole which can smooth entry of air into the hole, reducing turbulence and thus energy wastage.

The chamfer surface may or may not extend around the circumference of the hole.

The tapered portion of each hole may include a fillet surface.

The fillet provides an arcuate or trumpet-shaped surface of the hole which may advantageously reduce turbulence introduced into fluid flowing through the hole.

The hole may intersect the upstream face of the disc at the fillet surface.

Where a tapered portion of a hole comprises both a chamfer surface and a fillet surface, the fillet may be positioned between the chamfer surface and the upstream face of the disc. As another example, the fillet surface may comprise a surface over which the chamfer surface is ‘blended’ into a side wall of the hole.

The fillet surface may or may not extend around the circumference of the hole.

Each hole may include a reverse-tapered portion downstream of the tapered portion, the reverse-tapered portion widening from an upstream end to a downstream end thereof.

The reverse-tapered portion can act as a diffuser, decelerating air flow through the hole (which was accelerated by the flow constriction formed by the tapered portion). This can allow air to exit the downstream face of the disc more smoothly.

The reverse-tapered portion may define a taper angle of at least 5 degrees, for instance at least 10 degrees or at least 15 degrees. In some embodiments the tapered portion may define a taper angle of at least 20 degrees or at least 25 degrees.

Optionally, the disc is configured to rotate in a predetermined direction about the rotational axis; each hole intersects the upstream face of the edge at a mouth which has a leading edge and a trailing edge; and a forward part of the tapered portion, which is at or adjacent the leading edge, is steeper than a rearward part of the tapered portion, which is at or adjacent the trailing edge.

This can lead to an air flow, or a larger air flow, which passes over the forward part of the tapered portion and then impacts the rearward part of the tapered portion, dirt separation from said air flow being particularly effective.

Optionally, the holes are distributed over at least first and second regions of the disc, the second region being radially outward of the first region; and the porosity of the second region is higher than the porosity of the first region.

The porosity of the second region being higher can increase the proportion of fluid which passes through the disc in that region (whereas if the porosity was constant across both regions, more of the air would pass through the holes which were nearer the rotational axis). This, in turn, can provide several advantages. For instance, it can spread the flow of cleansed fluid through the disc more evenly across the diameter of the disc, reducing turbulence in the flow emerging from it. As another example, since the tangential velocity of the holes increases with their radial distance from the rotational axis, the holes of the second region may provide more effective separation of dirt. More air passing through the second region may therefore lead to an increase in overall separation performance.

For the avoidance of doubt, the porosity of a region of the disc can be defined as the open area of that portion of the disc (i.e. the area through which fluid can flow through) as a percentage of the total area of that region.

The first region may extend over at least 5%, for instance at least 10% or at least 20%, of the radial extent of the disc over which the holes are provided. Instead or as well, the second region may extend over at least 5%, for instance at least 10% or at least 20%, of the radial extent of the disc over which the holes are provided.

Optionally, the holes are distributed over a third region as well as the first and second regions, the third region being radially outward of the second region; and the porosity of the third region is higher than the porosity of the second region.

The disc having at least three regions of holes, increasing in porosity with increasing radial distance from the rotational axis, can provide a more smooth increase in porosity. Reducing the presence of abrupt changes in porosity can reduce turbulence in the flow through the disc.

The third region may extend over at least 5%, for instance at least 10% or at least 20%, of the radial extent of the disc over which the holes are provided.

The porosity of the disc may increase substantially continually across substantially the entire radial extent of the disc over which the holes are provided.

This may provide an even smoother increase in porosity, reducing turbulence yet further.

The porosity of the second region may be at least 10% larger than the porosity of the first region. For instance, the porosity of the second region may be at least 20%, at least 30% or at least 40% larger than the porosity of the first region.

Preferably, the porosity of the second region is at least 50% larger, for instance at least 60% larger or at least 70% larger, than the porosity of the first region.

A larger difference in porosity between the first and second regions may magnify the above advantages.

When viewed normal to the disc, each hole may be elongate and define a longitudinal axis which runs within the plane of the disc.

A hole may be considered to be elongate (when viewed normal to the disc) if it has one dimension (its ‘length’) which is larger than a dimension (its ‘width’) measured at 90 degrees to that dimension. Accordingly, examples of elongate shapes include ovals, ellipses, rectangles (other than squares), and more complex shapes such as a ‘racetrack’ shape which has straight sides and semicircular ends.

Each hole may extend across substantially the entire radial extent of the disc over which the holes are provided.

This may improve the ease of manufacture of the disc, in contrast to arrangements where multiple holes together span the total radial extent of the disc over which the holes are provided.

The longitudinal axis of each hole may be inclined relative to the radial direction of the disc.

This can allow the performance of the disc to be tailored to the requirements of the separator as a whole. For instance, if the holes are inclined so that their radially inner ends are forward (in the direction of rotation of the disc) of their radially outer ends, the disc can act as a centrifugal impeller (or do so to a greater extent), the outward flow of which can help to provide an air seal to prevent dirt-laden air from escaping around and behind the disc. As another example, if the holes are inclined so that their radially outer ends are forward of their radially inner ends, their longitudinal axes can be positioned nearer perpendicular to the flow of fluid across the disc. As a further example, if the holes are inclined in this way then the disc may tend to urge air radially inwards (or reduce the force with which air is urged outwards by the rotation of the disc). This may advantageously reduce aerodynamic pressure applied to a seal arrangement around the periphery of the disc.

The longitudinal axis of each hole may define an angle of at least 5 degrees, for instance at least 10 degrees, at least 20 degrees or at least 30 degrees, with the radial direction.

This may magnify one or more of the above advantages, in comparison to an arrangement where the holes are inclined at a smaller angle.

The longitudinal axis of each hole may be curved.

This allows the inclination of each hole (relative to the radial direction) to vary across the radial extent of that hole, thereby allowing the interaction between the dirt-laden fluid and the disc to vary at different radial points. For example, the longitudinal axis of each hole may be convex in the direction of rotation of the disc. This can allow the longitudinal axis of the hole to be positioned nearer to normal to the path of fluid across the disc, thereby potentially improving separation performance as discussed later. Instead or as well, it can allow the disc to function more effectively as a centrifugal impeller. As another example, the longitudinal axis of each hole may be concave in the direction of rotation of the disc. This may concentrate flow through the disc towards the radial centre of each hole, thereby reducing aerodynamic pressure exerted on sealing arrangements around the periphery and/or centre of the disc.

Where the longitudinal axis of a hole is curved, it may be considered to be inclined relative to the radial direction if the path taken by the longitudinal axis, from one axial end to another, defines a vector which is inclined relative to the radial direction of the disc.

The longitudinal axis of each hole may have a radius of curvature which is no more than four times, for instance no more than three times or no more than twice the radius of the disc. For example, the longitudinal axis of each hole may have a radius of curvature which is less than the radius of the disc.

Such a relatively tight radius may amplify one or more of the above advantages.

The disc may be configured to rotate about the rotational axis in a predetermined direction, and the longitudinal axis of each hole is convex in the direction of rotation of the disc.

This can allow the longitudinal axis of the hole to be positioned nearer to normal to the path of fluid across the disc, thereby potentially improving separation performance as discussed later. Instead or as well, it can allow the disc to function more effectively as a centrifugal impeller, the outward flow of which can help to provide an air seal to prevent dirt-laden air from escaping around and behind the disc.

Each hole may have a tapered portion which narrows from an upstream end to a downstream end thereof.

This may smooth the flow of air through the hole, in comparison to an arrangement where each hole has a constant cross sectional area or widens from the upstream end to the downstream end. Instead or as well, it may provide a greater opportunity for dirt which enters the hole to be separated rather than passing all the way through, as discussed in more detail later.

The tapered portion of each hole may include a chamfer surface positioned at the intersection between the hole and the upstream face of the disc.

The chamfer surface provides a sloped surface of the hole which can smooth entry of air into the hole, reducing turbulence and thus energy wastage.

The chamfer surface may or may not extend around the circumference of the hole.

The tapered portion of each hole may include a fillet surface.

The fillet provides an arcuate or trumpet-shaped surface of the hole which may advantageously reduce turbulence introduced into fluid flowing through the hole.

The hole may intersect the upstream face of the disc at the fillet surface.

Where a tapered portion of a hole comprises both a chamfer surface and a fillet surface, the fillet may be positioned between the chamfer surface and the upstream face of the disc. As another example, the fillet surface may comprise a surface over which the chamfer surface is ‘blended’ into a side wall of the hole.

The fillet surface may or may not extend around the circumference of the hole.

Each hole may include a reverse-tapered portion downstream of the tapered portion, the reverse-tapered portion widening from an upstream end to a downstream end thereof.

The reverse-tapered portion can act as a diffuser, decelerating air flow through the hole (which was accelerated by the flow constriction formed by the tapered portion). This can allow air to exit the downstream face of the disc more smoothly.

The reverse-tapered portion may define a taper angle of at least 5 degrees, for instance at least 10 degrees or at least 15 degrees. In some embodiments the tapered portion may define a taper angle of at least 20 degrees or at least 25 degrees.

Optionally, the disc is configured to rotate in a predetermined direction about the rotational axis; each hole intersects the upstream face of the edge at a mouth which has a leading edge and a trailing edge; and a forward part of the tapered portion, which is at or adjacent the leading edge, is steeper than a rearward part of the tapered portion, which is at or adjacent the trailing edge.

This can lead to an air flow, or a larger air flow, which passes over the forward part of the tapered portion and then impacts the rearward part of the tapered portion, dirt separation from said air flow being particularly effective.

Optionally, the disc is arranged to rotate in a predetermined direction about the rotational axis; and when viewed along the radial direction of the disc, the path of each hole through the thickness of the disc defines a centreline, the centreline being inclined such that it is non-perpendicular to the disc

This can allow the action of the holes (and thus of the disc as a whole) on the fluid to be better tailored to the requirements of the separator as a whole. For example, the centreline of each hole can be inclined such that that it intersects the upstream face of the disc at a point which is in forwards, in the direction of rotation of the disc, of the point at which the centreline intersects the downstream face of the disc. This can allow the disc to function as an axial impeller (or do so to a greater extent), thereby reducing the load placed on a vacuum motor arranged to draw fluid through the disc. As an alternative, it can allow the disc to function as a turbine such that fluid flow through the holes urges the disc to rotate, thereby reducing the load placed on a motor arranged to rotate the disc.

As another example, the centreline of each hole may be inclined such that it intersects the upstream face of the disc at a point which is behind, in the direction of rotation of the disc, the point at which the centreline intersects the downstream face of the disc.

This can reduce the risk of dirt particles passing through the holes, as discussed in more detail later.

The centreline may define an angle of less than 85 degrees, for instance less than 80 degrees or less than 75 degrees, with the plane of the disc.

For example, the centreline may define an angle of less than 70 degrees or less than 65 degrees with the plane of the disc.

The holes may be formed in a perforated region of the disc having an open area of at least 25%. As a result, a relatively large total open area may be achieved for the disc. By increasing the total open area of the disc, the axial speed of the fluid moving through the holes is likely to decrease. As a result, less dirt is likely to be carried by the fluid through the holes and thus an increase in separation efficiency may be observed. Additionally, by increasing the total open area of the disc, a smaller pressure drop across the dirt separator may be observed.

The diameter of the disc may be greater than the diameter of the inlet. This then has at least two benefits. First, a relatively large total open area may be achieved for the disc. Indeed, the disc may have a total open area greater than that of the inlet. As already noted, by increasing the total open area of the disc, the axial speed of the fluid moving through the holes is likely to decrease, as is the pressure drop associated with the dirt separator. Second, relatively high tangential speeds may be achieved by this disc. As the tangential speeds of the disc increase, the tangential forces imparted to the dirt-laden fluid by the disc increase. As a result, more dirt is likely to be separated from the fluid by the disc and thus an increase in separation efficiency may be observed.

The disc may comprise an inner region surrounded by an outer region, and the inner region may have an open area less than that of the outer region. In particular, the inner region may have an open area less than 10% and the outer region may have an open area greater than 20%. Since the tangential speed of the disc decreases from the perimeter to the centre of the disc, the tangential forces imparted to the dirt-laden fluid by the disc are smaller at the inner region. By ensuring that the open area of the inner region is smaller than that of the outer region, an increase in separation efficiency may be observed.

The diameter of the inner region may be no less than a third of the diameter of the disc. As a result, the majority of the holes are provided at a region of the disc where the tangential speeds and thus the tangential forces imparted to the dirt are relatively high. As a result, an increase in separation efficiency may be observed. Additionally, having a sizeable inner region with a smaller open area may increase the stiffness of the disc.

Additionally or alternatively, the diameter of the inner region may be no less than the diameter of the inlet. The dirt-laden fluid entering the chamber is then better encouraged to turn from an axial direction to a radial direction. This then has the benefit that the radial speed of the fluid moving over the holes is higher and thus less of the dirt carried by the fluid is able to match the turn and pass axially through the holes. Relatively hard objects carried by the fluid may impact the disc and puncture or otherwise damage the land between holes. By having an inner region of the disc that is at least the same size as the inlet and has a smaller open area, the risk of the damaging the disc is reduced. In particular, by having a smaller open area, the land between holes is greater and thus the risk of dirt puncturing the land is reduced.

The holes may be formed in the outer region and the inner region may be non-perforated. By ensuring that the inner region is non-perforated, the holes are provided at a region of the disc where the tangential speeds and thus the tangential forces imparted to the dirt are relatively high. As a result, an increase in separation efficiency may be observed. Additionally, damage arising from hard objects impacting the disc may be reduced.

The dirt-laden fluid entering the chamber may be directed at the disc. That is to say that the dirt-laden fluid may enter the chamber via the inlet along a flow axis that intersects the disc. The provision of a rotating disc within a dirt separator of a vacuum cleaner is known. However, there is an existing prejudice that the dirt separator must include a cyclone chamber to separate the dirt from the fluid. The disc is then used merely as an auxiliary filter to remove residual dirt from the fluid as it exits the cyclone chamber. There is a further prejudice that the rotating disc must be protected from the bulk of the dirt that enters the cyclone chamber. As a result, the dirt-laden fluid is introduced into the cyclone chamber in a manner that avoids direct collision with the disc. However, by directing the dirt-laden fluid at the disc, the dirt is subjected to relatively high tangential forces upon contact with the rotating disc. Dirt within the fluid is then thrown radially outward whilst the fluid passes axially through the holes in the disc. As a result, effective dirt separation may be achieved without the need for cyclonic flow.

The dirt-laden fluid entering the chamber may be directed at the centre of the disc. That is to say that the flow axis may intersect the centre of the disc. This then has the advantage that the flow of the dirt-laden fluid over the surface of the disc may be more evenly distributed. By contrast, if the dirt-laden fluid were directed off-centre at the disc, the fluid would most likely be unevenly distributed. The axial speed of the fluid moving through the holes may then increase at those regions of the disc that are most heavily loaded, resulting in a decrease in separation efficiency. Additionally, dirt separated from the fluid may collect unevenly within the chamber, thereby compromising the capacity of the dirt separator. Re-entrainment of dirt may also increase, leading to a further decrease in the separation efficiency. A further disadvantage of directing the dirt-laden fluid off-centre is that the disc may be subjected to uneven structural load. The resulting imbalance may lead to increased vibration and noise, and/or may reduce the lifespan of any bearings used to support the rotating disc.

The holes may be formed by chemical etching or laser machining. As a result, a large number of holes at the specified dimensions may be accurately formed in a timely and cost-effective manner.

The dirt separator may comprise an electric motor for driving the disc. As a result, the speed of the disc and thus the tangential forces imparted to the dirt are relatively insensitive to flow rates and fluid speeds. Consequently, in contrast to a turbine, relatively high separation efficiencies may be achieved at relatively low flow rates.

The disc may be at least 1 mm, for instance at least 1.5 mm or at least 2 mm thick. This may make the disc advantageously strong and/or may allow the disc to be used for a longer time before the disc wears through due to abrasion from dirt. It may also allow the effect of holes with inclined centrelines and/or tapered portions to have a greater impact on the behaviour of the disc.

The disc may be less than 10 mm, for instance less than 8 mm, less than 6 mm or less than 4 mm thick. This may advantageously reduce the weight and inertia of the disc in comparison to a thicker disc.

The disc may be made of plastic, such as nylon or polypropylene. This may advantageously reduce the weight and inertia, and/or the cost or complexity of manufacture, of the disc in comparison to a disc made of metal.

According to a second aspect of the present invention there is provided a vacuum cleaner comprising a dirt separator according to the first aspect of the invention.

The vacuum cleaner may be a handheld vacuum cleaner (for instance a battery-powered handheld vacuum cleaner). Although the provision of a rotating disc within a dirt separator of a vacuum cleaner is known, there is an existing prejudice that the dirt separator must include a cyclone chamber to separate the dirt from the fluid. As a result, the overall size of the dirt separator is relatively large and is unsuited for use in a handheld unit. With the dirt separator according to various aspects of the present invention, effective separation may be achieved in a relatively compact manner. As a result, the dirt separator is particularly well suited for use in a handheld unit.

The vacuum cleaner may be a stick vacuum cleaner comprising a handheld unit attached to a cleaner head by an elongate tube, the handheld unit comprising the dirt separator, and the elongate tube extending along an axis parallel to the rotational axis.

By having an elongate tube that extends parallel to the rotational axis, dirt-laden fluid may be carried from the cleaner head to the dirt separator and the rotating disc along a relatively straight path. As a result, pressure losses may be reduced.

The elongate tube may extend along an axis that is collinear with the rotational axis.

### BRIEF DESCRIPTION OF THE FIGURES

In order that the present invention may be more readily understood, embodiments of the invention will now be described, by way of example, with reference to the accompanying drawings in which:

FIG. 1 is a perspective view of a vacuum cleaner;

FIG. 2 is a section through a part of the vacuum cleaner;

FIG. 3 is a section through a dirt separator of the vacuum cleaner;

FIG. 4 is a plan view of a disc of the dirt separator;

FIG. 5 illustrates the flow of dirt-laden fluid through the dirt separator;

FIG. 6 illustrates emptying of the dirt separator;

FIG. 7 is a section through a part of the vacuum cleaner when used for above-floor cleaning;

FIG. 8 illustrates the tangential forces imparted by the disc to the dirt-laden fluid at the circumference of an inlet duct that is (a) directed at the centre of the disc and (b) is directed off-centre;

FIG. 9 is a section through a first alternative dirt separator;

FIG. 10 is a section through a part of a vacuum cleaner having a second alternative dirt separator;

FIG. 11 is a section through a third alternative dirt separator;

FIG. 12 is a section through a part of a vacuum cleaner having the third alternative dirt separator;

FIG. 13 illustrates emptying of the third alternative dirt separator;

FIG. 14 is a section through a fourth alternative dirt separator;

FIG. 15 illustrates alternative hole shapes and sizes for the disc forming part of any one of the dirt separators;

FIG. 16 shows a further alternative disc for use in one of the dirt separators;

FIG. 17 is a schematic another disc design for use in one of the dirt separators;

FIG. 18 shows an additional disc design;

FIG. 19 shows part of another disc design, viewed in cross section in the radial direction;

FIG. 20 shows part of a further disc design, viewed in cross section in the radial direction;

FIG. 21 shows part of a still further disc design, viewed in cross section in the radial direction;

FIG. 22 shows part of another disc design, viewed in cross section in the radial direction; and

FIG. 23 illustrates an alternative disc assembly that may form part of any one of the dirt separators.

### DETAILED DESCRIPTION OF THE DISCLOSURE

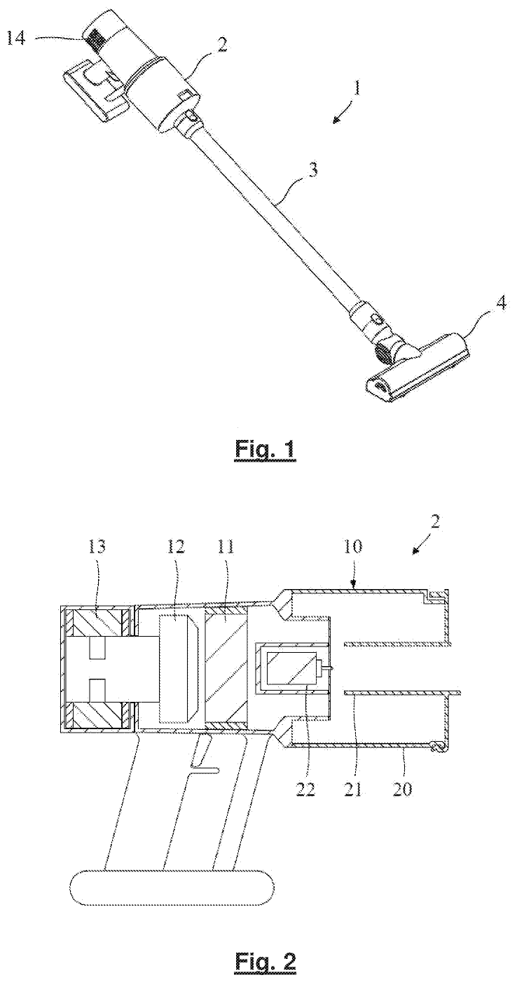

The vacuum cleaner 1 of FIG. 1 comprises a handheld unit 2 attached to a cleaner head 4 by means of an elongate tube 3. The elongate tube 3 is detachable from the handheld unit 2 such that the handheld unit 2 may be used as a standalone vacuum cleaner.

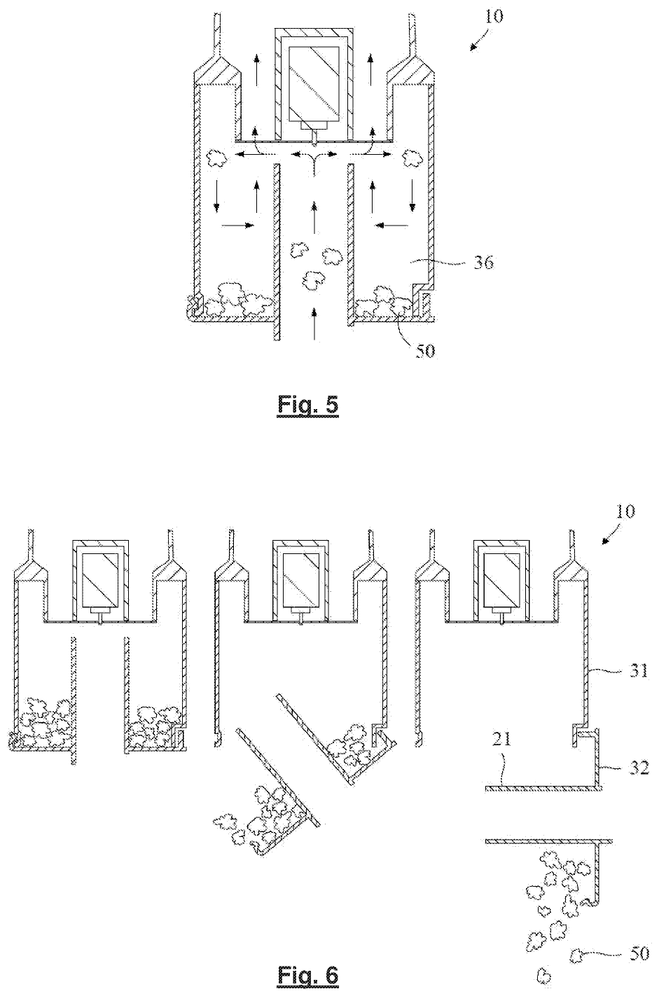

Referring now to FIGS. 2 to 7, the handheld unit 2 comprises a dirt separator 10, a pre-motor filter 11, a vacuum motor 12 and a post-motor filter 13. The pre-motor filter 11 is located downstream of the dirt separator 10 but upstream of the vacuum motor 12, and the post-motor filter 13 is located downstream of the vacuum motor 12. During use, the vacuum motor 12 causes dirt-laden fluid to be drawn in through a suction opening in the underside of the cleaner head 4. From the cleaner head 4, the dirt-laden fluid is drawn along the elongate tube 3 and into the dirt separator 10. Dirt is then separated from the fluid and retained within the dirt separator 10. The cleansed fluid exits the dirt separator 10 and is drawn through the pre-motor filter 11, which removes residual dirt from the fluid before passing through the vacuum motor 12. Finally, the fluid expelled by the vacuum motor 12 passes through the post-motor filter 13 and is exhausted from the vacuum cleaner 1 via vents 14 in the handheld unit 2.

The dirt separator comprises a container 20, an inlet duct 21, and a disc assembly 22.

The container 20 comprises a top wall 30, a side wall 31, and a bottom wall 32 that collectively define a chamber 36. An opening in the centre of the top wall defines an outlet 38 of the chamber 36. The bottom wall 32 is attached to the side wall 31 by means of a hinge 33. A catch 34 attached to the bottom wall 32 engages with a recess in the side wall 31 to hold the bottom wall 32 in a closed position. Releasing the catch 34 then causes the bottom wall 32 to swing to an open position, as illustrated in FIG. 6.

The inlet duct 21 extends upwardly through the bottom wall 32 of the container 20. The inlet duct 21 extends centrally within the chamber 36 and terminates a short distance from the disc assembly 22. One end of the inlet duct 21 defines an inlet 37 of the chamber 36. The opposite end of the inlet duct 21 is attachable to the elongate tube 3 or an accessory tool when the handheld unit 2 is used as a standalone cleaner.

The disc assembly 22 comprises a disc 40 coupled to an electric motor 41. The electric motor 41 is located outside of the chamber 36, and the disc 40 is located at and covers the outlet 38 of the chamber 36. When powered on, the electric motor 41 causes the disc 40 to rotate about a rotational axis 48. The disc 40 is formed of a metal and comprises a central non-perforated region 45 surrounded by a perforated region 46. The periphery of the disc 40 overlies the top wall 30 of the container 20. As the disc 40 rotates, the periphery of the disc 40 contacts and forms a seal with the top wall 30. In order to reduce friction between the disc 40 and the top wall 30, a ring of low-friction material (e.g. PTFE) may be provided around the top wall 30.

During use, the vacuum motor 12 causes dirt-laden fluid to be drawn into the chamber 36 via the inlet 37. The inlet duct 21 extends centrally within the chamber 36 along an axis that is coincident with the rotational axis 48 of the disc 40. As a result, the dirt-laden fluid enters the chamber 36 in an axial direction (i.e. in a direction parallel to the rotational axis 48). Moreover, the dirt-laden fluid is directed at the centre of the disc 40. The central non-perforated region of the disc 40 causes the dirt-laden fluid to turn and move radially outward (i.e. in a direction normal to the rotational axis). The rotating disc 40 imparts tangential forces to the dirt-laden fluid, causing the fluid to swirl. As the dirt-laden fluid moves radially outward, the tangential forces imparted by the disc 40 increase. Upon reaching the perforated region 46 of the disc 40, the fluid is drawn axially through the holes 47 in the disc 40. This requires a further turn in the direction of the fluid. The inertia of the larger and heavier dirt is too great to allow the dirt to follow the fluid. As a result, rather than being drawn through the holes 47, the dirt continues to move radially outwards and eventually collects at the bottom of the chamber 36. Smaller and lighter dirt may follow the fluid through the disc 40. The bulk of this dirt is then subsequently removed by the pre-motor and post-motor filters 11,13. In order to empty the dirt separator 10, the catch 34 is released and the bottom wall 32 of the container 20 swings open. As illustrated in FIG. 6, the container 20 and the inlet duct 21 are configured such that the inlet duct 21 does not prevent or otherwise hinder the movement of the bottom wall 32.

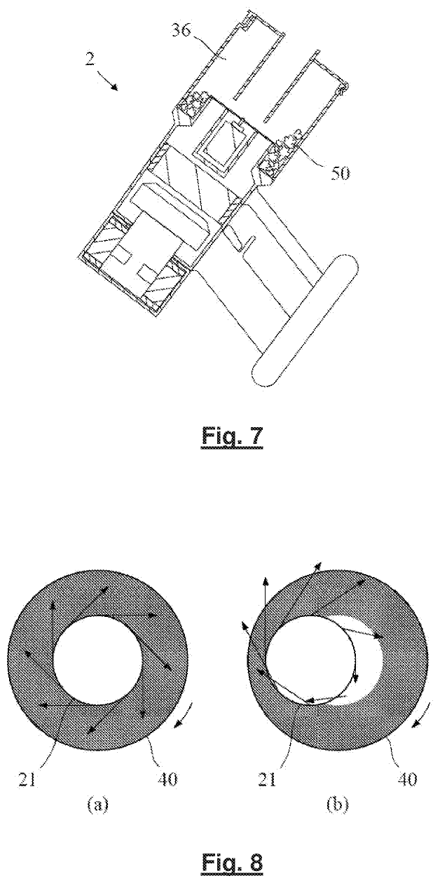

In addition to cleaning floor surfaces, the vacuum cleaner 1 may be used to clean above-floor surfaces such as shelves, curtains or ceilings. When cleaning these surfaces, the handheld unit 2 may be inverted as shown in FIG. 7. Dirt 50 collected in the chamber 36 may then fall down towards the disc 40. Any dirt falling onto the disc 40 is likely to be drawn through or block some of the holes 47 in the perforated region 46. As a result, the available open area of the disc 40 will decrease and the speed of the fluid moving axially through the disc 40 will increase. More dirt is then likely to be carried by the fluid through the disc 40 and thus the separation efficiency of the dirt separator 10 is likely to decrease. The top wall 30 of the container 20 is not flat but is instead stepped. As a result, the chamber 36 comprises a gulley located between the side wall 31 and the step in the top wall 30. This gulley surrounds the disc 40 and acts to collect dirt 50 that falls down the chamber 36. As a result, less dirt is likely to fall onto the disc 40 when the handheld unit 2 is inverted.

The dirt separator 10 has several advantages over a conventional separator that employs a porous bag. The pores of a bag quickly clog with dirt during use. This then reduces the suction that is achieved at the cleaner head. Additionally, the bag must normally be replaced when full, and it is not always easy to determine when the bag is full. With the dirt separator described herein, rotation of the disc 40 ensures that the holes 47 in the perforated region 46 are generally kept clear of dirt. As a result, no significant reduction in suction is observed during use. Additionally, the dirt separator 10 may be emptied by opening the bottom wall 32 of the container 20, thus avoiding the need for replacement bags. Furthermore, by employing a transparent material for the side wall 31 of the container 20, a user is able to determine with relative ease when the dirt separator 10 is full and requires emptying. The aforementioned disadvantages of a porous bag are well known and are solved equally well by a separator that employs cyclonic separation. However, the dirt separator 10 described herein also has advantages over a cyclonic separator.

In order to achieve a relatively high separation efficiency, the cyclonic separator of a vacuum cleaner typically comprises two or more stages of separation. The first stage often comprises a single, relatively large cyclone chamber for removing coarse dirt, and the second stage comprises a number of relatively small cyclone chambers for removing fine dirt. As a result, the overall size of the cyclonic separator can be relatively large. A further difficulty with the cyclonic separator is that it requires high fluid speeds in order to achieve high separation efficiencies. Furthermore, the fluid moving through the cyclonic separator often follows a relatively long path as it travels from the inlet to the outlet. The long path and high speeds result in high aerodynamic losses. As a result, the pressure drop associated with the cyclonic separator can be high. With the dirt separator described herein, relatively high separation efficiencies can be achieved in a more compact manner. In particular, the dirt separator comprises a single stage having a single chamber. Furthermore, separation occurs primarily as a result of the angular momentum imparted to the dirt-laden fluid by the rotating disc 40. As a result, relatively high separation efficiencies can be achieved at relatively low fluid speeds. Additionally, the path taken by the fluid in moving from the inlet 37 to the outlet 38 of the dirt separator 10 is comparatively short. As a consequence of the lower fluid speeds and shorter path, aerodynamic losses are smaller. As a result, the pressure drop across the dirt separator 10 is smaller than that across the cyclonic separator, for the same separation efficiency. The vacuum cleaner 1 is therefore able to achieve the same cleaning performance as that of a cyclonic vacuum cleaner using a less powerful vacuum motor. This is particularly important should the vacuum cleaner 1 be powered by a battery, since any reduction in the power consumption of the vacuum motor 11 may be used to increase the runtime of the vacuum cleaner 1.

The provision of a rotating disc within a dirt separator of a vacuum cleaner is known. For example, DE19637431 and U.S. Pat. No. 4,382,804 each describe a dirt separator having a rotating disc. However, there is an existing prejudice that the dirt separator must include a cyclone chamber to separate the dirt from the fluid. The disc is then used merely as an auxiliary filter to remove residual dirt from the fluid as it exits the cyclone chamber. There is a further prejudice that the rotating disc must be protected from the bulk of the dirt that enters the cyclone chamber. The dirt-laden fluid is therefore introduced into the cyclone chamber in a manner that avoids direct collision with the disc.

The dirt separator described herein exploits the finding that dirt separation may be achieved with a rotating disc without the need for a cyclone chamber. The dirt separator further exploits the finding that effective dirt separation may be achieved by introducing the dirt-laden fluid into a chamber in a direction directly towards the disc. By directing the dirt-laden fluid at the disc, the dirt is subjected to relatively high forces upon contact with the rotating disc. Dirt within the fluid is then thrown radially outward whilst the fluid passes axially through the holes in the disc. As a result, effective dirt separation is achieved without the need for cyclonic flow.

The separation efficiency of the dirt separator 10 and the pressure drop across the dirt separator 10 are sensitive to the size of the holes 47 in the disc 40. For a given total open area, the separation efficiency of the dirt separator 10 increases as the hole size decreases. However, the pressure drop across the dirt separator 10 also increases as the hole size decreases. The separation efficiency and the pressure drop are also sensitive to the total open area of the disc 40. In particular, as the total open area increases, the axial speed of the fluid moving through the disc 40 decreases. As a result, the separation efficiency increases and the pressure drop decreases. It is therefore advantageous to have a large total open area. However, increasing the total open area of the disc 40 is not without its difficulties. For example, as already noted, increasing the size of the holes in order to increase the total open area may actually decrease the separation efficiency. As an alternative, the total open area may be increased by increasing the size of the perforated region 46. This may be achieved by increasing the size of the disc 40 or by decreasing the size of the non-perforated region 45. However, each of these options has its disadvantages. For example, since a contact seal is formed between the periphery of the disc 40 and the top wall 30, more power will be required to drive a disc 40 having a larger diameter. Additionally, a rotating disc 40 of larger diameter may generate more stirring within the chamber 36. As a result, re-entrainment of dirt already collected in the chamber 36 may increase and thus there may actually be a net decrease in the separation efficiency. On the other hand, if the diameter of the non-perforated region 45 were decreased then, for reasons detailed below, the axial speed of the fluid moving through the disc 40 may actually increase. Another way of increasing the total open area of the disc 40 is to decrease the land between the holes 47. However, decreasing the land has its own difficulties. For example, the stiffness of the disc 40 is likely to decrease and the perforated region 46 is likely to become more fragile and thus more susceptible to damage. Additionally, decreasing the land between holes may introduce manufacturing difficulties. There are therefore many factors to consider in the design of the disc 40.

The disc 40 comprises a central non-perforated region 45 surrounded by a perforated region 46. The provision of a central non-perforated region 45 has several advantages, which will now be described.

The stiffness of the disc 40 may be important in achieving an effective contact seal between the disc 40 and the top wall 30 of the container 20. Having a central region 45 that is non-perforated increases the stiffness of the disc 40. As a result, a thinner disc may be employed. This then has the benefit that the disc 40 may be manufactured in a more timely and cost-effective manner. Moreover, for certain methods of manufacture (e.g. chemical etching), the thickness of the disc 40 may define the minimum possible dimensions for the holes 47 and land. A thinner disc therefore has the benefit that such methods may be used to manufacture a disc having relatively small hole and/or land dimensions. Furthermore, the cost and/or weight of the disc 40, along with the mechanical power required to drive the disc 40, may be reduced. Consequently, a less powerful, and potentially smaller and cheaper motor 41 may be used to drive the disc 40.

By having a central non-perforated region 45, the dirt-laden fluid entering the chamber 36 is forced to turn from an axial direction to a radial direction. The dirt-laden fluid then moves outward over the surface of the disc 40. This then has at least two benefits. First, as the dirt-laden fluid moves over the perforated region 46, the fluid is required to turn through a relatively large angle (around 90 degrees) in order to pass through the holes 47 in the disc 40. As a result, less of the dirt carried by the fluid is able to match the turn and pass through the holes 47. Second, as the dirt-laden fluid moves outward over the surface of the disc 40, the dirt-laden fluid helps to scrub the perforated region 46. Consequently, any dirt that may have become trapped at a hole 47 is swept clear by the fluid.

The tangential speed of the disc 40 decreases from the perimeter to the centre of the disc 40. As a result, the tangential forces imparted to the dirt-laden fluid by the disc 40 decrease from the perimeter to the centre. If the central region 45 of the disc 40 were perforated, more dirt is likely to pass through the disc 40. By having a central non-perforated region 45, the holes 47 are provided at regions of the disc 40 where the tangential speeds and thus the tangential forces imparted to the dirt are relatively high.

As the dirt-laden fluid introduced into the chamber 36 turns from axial to radial, relatively heavy dirt may continue to travel in an axial direction and impact the disc 40. If the central region 45 of the disc 40 were perforated, relatively hard objects impacting the disc 40 may puncture or otherwise damage the land between the holes 47. By having a central region 45 that is non-perforated, the risk of damaging the disc 40 is reduced.

The diameter of the non-perforated region 45 is greater than the diameter of the inlet 37. As a result, hard objects carried by the fluid are less likely to impact the perforated region 46 and damage the disc 40. Additionally, the dirt-laden fluid is better encouraged to turn from an axial direction to a radial direction on entering the chamber 36. The separation distance between the inlet 37 and the disc 40 plays an important part in achieving both these benefits. As the separation distance between the inlet 37 and the disc 40 increases, the radial component of the velocity of the dirt-laden fluid at the perforated region 46 of the disc 40 is likely to decrease. As a result, more dirt is likely to be carried through the holes 47 in the disc 40. Additionally, as the separation distance increases, hard objects carried by the fluid are more likely to impact the perforated region 46 and damage the disc 40. A relatively small separation distance is therefore desirable. However, if the separation distance is too small, dirt larger than the separation distance will be unable to pass between the inlet duct 21 and the disc 40 and will therefore become trapped. The size of the dirt carried by the fluid will be limited by, among other things, the diameter of the inlet duct 21. In particular, the size of the dirt is unlikely to be greater than the diameter of the inlet duct 21. Accordingly, by employing a separation distance that is no greater than the diameter of the inlet 37, the aforementioned benefits may be achieved whilst providing sufficient space for dirt to pass between the inlet duct 21 and the disc 40.

Irrespective of the separation distance that is chosen, the non-perforated region 45 of the disc 40 continues to provide advantages. In particular, the non-perforated region 45 ensures that the holes 47 in the disc 40 are provided at regions where tangential forces imparted to the dirt by the disc 40 are relatively high. Additionally, although the dirt-laden fluid follows a more divergent path as the separation distance increases, relatively heavy objects are still likely to continue along a relatively straight path upon entering the chamber 36. A central non-perforated region 45 therefore continues to protect the disc 40 from potential damage.

In spite of the advantages, the diameter of the non-perforated region 45 need not be greater than the diameter of the inlet 37. By decreasing the size of the non-perforated region 45, the size of the perforated region 46 and thus the total open area of the disc 46 may be increased. As a result, the pressure drop across the dirt separator 10 is likely to decrease. Additionally, a decrease in the axial speed of the dirt-laden fluid moving through the perforated region 46 may be observed. However, as the size of the non-perforated region 45 decreases, there will come a point at which the fluid entering the chamber 36 is no longer forced to turn from axial to radial before encountering the perforated region 46. There will therefore come a point at which the decrease in axial speed due to the larger open area is offset by the increase in axial speed due to the smaller turn angle.

Conceivably, the central region 45 of the disc 40 may be perforated. Although many of the advantages described above would then be forfeited, there may nevertheless be advantages in having a disc 40 that is fully perforated. For example, it may be simpler and/or cheaper to manufacture the disc 40. In particular, the disc 40 may be cut from a continuously perforated sheet. Even if the central region 45 were perforated, the disc 40 would continue to impart tangential forces to the dirt-laden fluid entering the chamber 36, albeit smaller forces at the centre of the disc 40. The disc 40 would therefore continue to separate dirt from the fluid, albeit at a reduced separation efficiency. Additionally, if the central region 45 of the disc 40 were perforated, dirt may block the holes at the very centre of the disc 40 owing to the relatively low tangential forces imparted by the disc 40. With the holes at the very centre blocked, the disc 40 would then behave as if the centre of the disc 40 were non-perforated. Alternatively, the central region 45 may be perforated but have an open area that is less than that of the surrounding perforated region 46. Moreover, the open area of the central region 45 may increase as one moves radially outward from the centre of the disc 40. This then has the benefit that the open area of the central region 45 increases as the tangential speed of the disc 40 increases.

The inlet duct 21 extends along an axis that is coincident with the rotational axis 48 of the disc 40. As a result, the dirt-laden fluid entering the chamber 36 is directed at the centre of the disc 40. This then has the advantage that the dirt-laden fluid is distributed evenly over the surface of the disc 40. By contrast, if the inlet duct 21 were directed off-centre at the disc 40, the fluid would be unevenly distributed. In order to illustrate this point, FIG. 8 shows the tangential forces imparted to the dirt-laden fluid by the disc at the circumference of an inlet duct 21 that is (a) directed at the centre of the disc 40 and (b) is directed off-centre. It can be seen that, when the inlet duct 21 is directed off-centre, the dirt-laden fluid does not flow evenly over the surface of the disc 40. In the example shown in FIG. 8(b), the lower half of the disc 40 sees very little of the dirt-laden fluid. This uneven distribution of fluid over the disc 40 is likely to have one or more adverse effects. For example, the axial speed of the fluid through the disc 40 is likely to increase at those regions that are most heavily exposed to the dirt-laden fluid. As a result, the separation efficiency of the dirt separator 10 is likely to decrease. Additionally, dirt separated by the disc 40 may collect unevenly within the container 20. As a result, the capacity of the dirt separator 10 may be compromised. Re-entrainment of dirt 50 already collected within the container 20 may also increase, leading to a further decrease in the separation efficiency. A further disadvantage of directing the dirt-laden fluid off-centre is that the disc 40 is subjected to uneven structural load. The resulting imbalance may lead to a poor seal with the top wall 30 of the container 20, and may reduce the lifespan of any bearings used to support the disc assembly 22 within the vacuum cleaner 1.

The inlet duct 21 is attached to and may be formed integrally with the bottom wall 32. The inlet duct 21 is therefore supported within the chamber by the bottom wall 32. The inlet duct 21 may alternatively be supported by the side wall 31 of the container 20, e.g. using one or more braces that extend radially between the inlet duct 21 and the side wall 31. This arrangement has the advantage that the bottom wall 32 is free to open and close without movement of the inlet duct 21. As a result, a taller container 20 having a larger dirt capacity may be employed. However, a disadvantage with this arrangement is that the braces used to support the inlet duct 21 are likely to inhibit dirt falling from the chamber 36 when the bottom wall 32 is opened, thus making emptying of the container 20 more difficult.

The inlet duct 21 extends linearly within the chamber 36. This then has the advantage that the dirt-laden fluid moves through the inlet duct 21 along a straight path. However, this arrangement is not without its difficulties. The bottom wall 32 is arranged to open and close and is attached to the side wall 31 by means of a hinge 33 and catch 34. Accordingly, when a user applies a force to the handheld unit 2 in order to manoeuvre the cleaner head 4 (e.g. a push or pull force in order to manoeuvre the cleaner head 4 forwards and backwards, a twisting force in order to steer the cleaner head 4 left or right, or a lifting force in order to lift the cleaner head 4 off the floor), the force is transferred to the cleaner head 4 via the hinge 33 and catch 34. The hinge 33 and catch 34 must therefore be designed in order to withstand the required forces. As an alternative arrangement, the bottom wall 32 may be fixed to the side wall 31, and the side wall 31 may be removably attached to the top wall 30. The container 20 is then emptied by removing the side and bottom walls 31,32 from the top wall 30 and inverting. Although this arrangement has the advantage that it is not necessary to design a hinge and catch capable of withstanding the required forces, the dirt separator 10 is less convenient to empty.

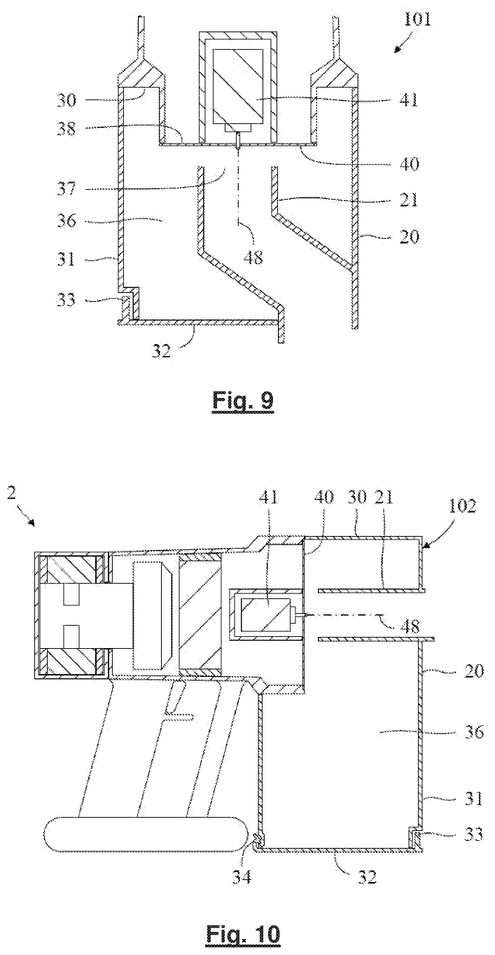

An alternative dirt separator 101 is illustrated in FIG. 9. Part of the inlet duct 21 extends along and is attached to or is formed integrally with the side wall 31 of the container 20. The bottom wall 32 is again attached to the side wall 31 by a hinge 33 and catch (not shown). However, the inlet duct 21 no longer extends through the bottom wall 32. Accordingly, when the bottom wall 32 moves between the closed and opened positions, the position of the inlet duct 21 is unchanged. This then has the advantage that the container 20 is convenient to empty without the need to design a hinge and catch capable of withstanding the required forces. However, as is evident from FIG. 9, the inlet duct 21 is no longer straight. As a result, there will be increased losses due to the bends in the inlet duct 21 and thus the pressure drop associated with the dirt separator 10 is likely to increase. Although the inlet duct 21 of the arrangement shown in FIG. 9 is no longer straight, the end portion of the inlet duct 21 continues to extend along an axis that is coincident with the rotational axis 48 of the disc 40. As a result, the dirt-laden fluid continues to enter the chamber 36 in an axial direction that is directed at the centre of the disc 40.

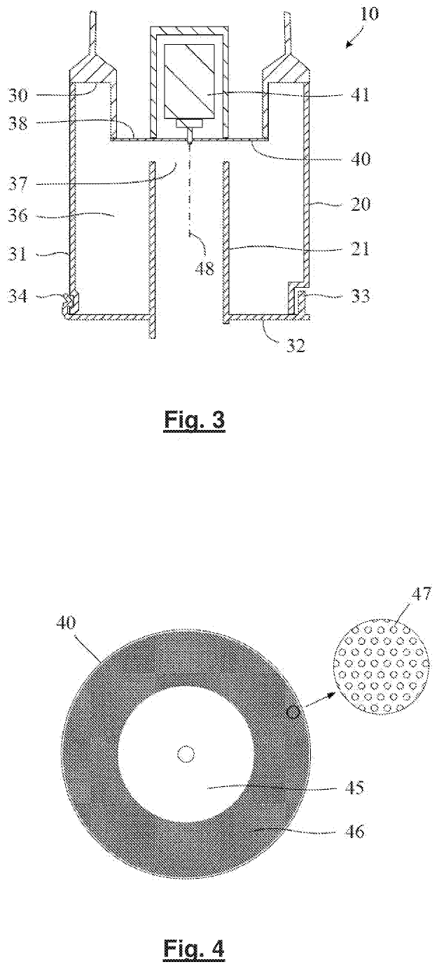

FIG. 10 illustrates a further dirt separator 102 in which the inlet duct 21 extends linearly through the side wall 31 of the container 20. The bottom wall 32 is then attached to the side wall 31 by means of a hinge 33 and is held closed by a catch 34. In the arrangements illustrated in FIGS. 3 and 9, the chamber 36 of the dirt separator 10,101 is essentially cylindrical in shape, with the longitudinal axis of the chamber 36 coincident with the rotational axis 48 of the disc. The disc 40 is then located towards the top of the chamber 36, and the inlet duct 21 extends upwardly from the bottom of the chamber 36. Reference to top and bottom should be understood to mean that dirt separated from the fluid collects preferentially at the bottom of the chamber 36, and fills progressively in a direction towards the top of the chamber 36. With the arrangement shown in FIG. 10, the shape of the chamber 36 may be thought of as the union of a cylindrical top portion and a cubical bottom portion. Both the disc 40 and the inlet duct 21 are then located towards the top of the chamber 36. Since the inlet duct 21 extends through the side wall 31 of the container 20, this arrangement has the advantage that the container 20 may be conveniently emptied via the bottom wall 32 without the need for a hinge and catch capable of withstanding the forces required to manoeuvre the cleaner head 4. Additionally, since the inlet duct 21 is linear, pressure losses associated with the inlet duct 21 are reduced. The arrangement has at least three further advantages. First, the dirt capacity of the dirt separator 102 is significantly increased. Second, when the handheld unit 2 is inverted for above-floor cleaning, dirt within the container 20 is less likely to fall onto the disc 40. There is therefore no need for the chamber 36 to include a protective gulley around the disc 40, and thus a larger disc 40 having a larger total open area may be used. Third, the bottom wall 32 of the container 20 may be used to support the handheld unit 2 when resting on a level surface. This arrangement is not, however, without its disadvantages. For example, the larger container 20 may obstruct access to narrow spaces, such as between items of furniture or appliances. Additionally, the bottom of the chamber 36 is spaced radially from the top of the chamber 36. That is to say that the bottom of the chamber 36 is spaced from the top of the chamber 36 in a direction normal to the rotational axis 48 of the disc 40. As a result, dirt and fluid thrown radially outward by the disc 40 may disturb the dirt collected in the bottom of the chamber 36. Additionally, any swirl within the chamber 36 will tend to move up and down the chamber 36. Consequently, re-entrainment of dirt may increase, resulting in a decrease in separation efficiency. By contrast, in the arrangements illustrated in FIGS. 3 and 9, the bottom of the chamber 36 is spaced axially from the top of the chamber 36. Dirt and fluid thrown radially outward by the disc 40 is therefore less likely to disturb the dirt collected in the bottom of the chamber 36. Additionally, any swirl within the chamber 36 moves around the chamber 36 rather than up and down the chamber 36.

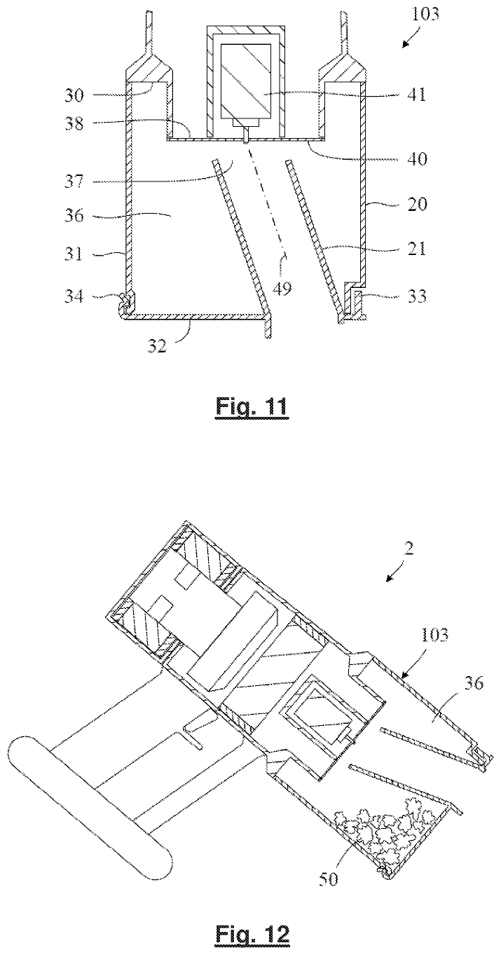

In each of the dirt separators 10,101,102 described above, at least the end portion of the inlet duct 21 (i.e. that portion having the inlet 37) extends along an axis that is coincident with the rotational axis 48 of the disc 40. As a result, the dirt-laden fluid enters the chamber 36 in an axial direction that is directed at the centre of the disc 40. The advantages of this have been described above. However, there may instances for which it is desirable to have an alternative arrangement. For example, FIGS. 11-13 illustrate a dirt separator 103 in which the inlet duct 21 extends along an axis that is angled relative to the rotational axis 48 of the disc 40. That is to say that the inlet duct 21 extends along an axis that is non-parallel to the rotational axis 48. As a consequence of this arrangement, the dirt-laden fluid enters the chamber in a direction that is non-parallel to the rotational axis 48. Nevertheless, the dirt-laden fluid entering the chamber 36 continues to be directed at the disc 40. Indeed, with the dirt separator 103 shown in FIGS. 11-13, the dirt-laden fluid continues to be directed at the centre of the disc 40. This particular arrangement may be advantageous for a couple of reasons. First, when the vacuum cleaner 1 is used for floor cleaning, as shown in FIG. 1, the handheld unit 2 is generally directed downwards at an angle of about 45 degrees. As a result, dirt may collect unevenly within the dirt separator. In particular, dirt may collect preferentially along one side of the chamber 36. With the dirt separator 10 shown in FIG. 3, this uneven collection of dirt may mean that dirt fills to the top of the chamber 36 along one side, thus triggering a chamber-full condition, even though the opposite side of the chamber 36 may be relatively free of dirt. As illustrated in FIG. 12, the dirt separator 103 of FIGS. 11-13 may make better use of the available space. As a result, the capacity of the dirt separator 10 may be improved. The dirt separator 101 of FIG. 9 may also be said to have this advantage. However, the inlet duct 21 of the dirt separator 101 includes two bends. By contrast, the inlet duct 21 of the dirt separator 103 of FIGS. 11-13 is generally linear, and thus pressure losses are smaller. A further advantage of the arrangement shown in FIGS. 11-13 relates to emptying. As with the arrangement shown in FIG. 3, the inlet duct 21 is attached to and is moveable with the bottom wall 32. As shown in FIG. 6, when the dirt separator 10 of FIG. 3 is held vertically and the bottom wall 32 is in the open position, the inlet duct 21 extends horizontally. By contrast, as shown in FIG. 13, when the dirt separator 103 of FIGS. 11-13 is held vertically and the bottom wall 32 is opened, the inlet duct 21 is inclined downward. As a result, dirt is better encouraged to slide off the inlet duct 21.

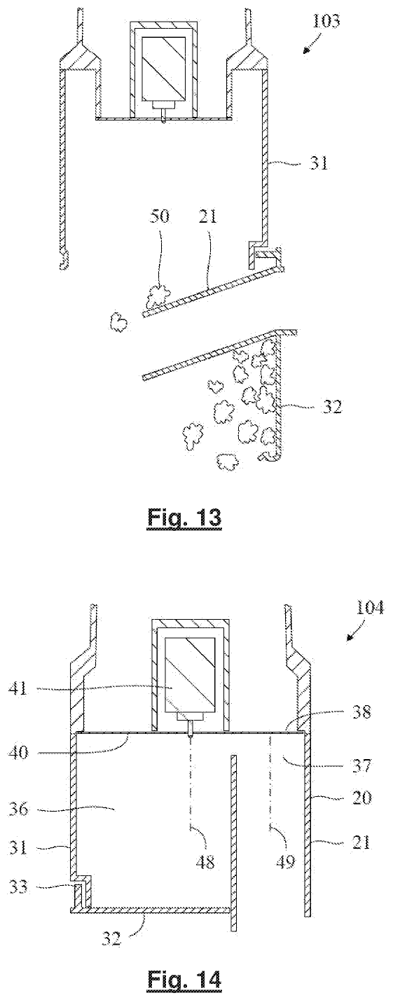

In the arrangement shown in FIGS. 11-13, the dirt-laden fluid entering the chamber 36 continues to be directed at the centre of the disc 40. Although there are advantages in this arrangement, effective separation of dirt may nevertheless be achieved by directing the dirt-laden fluid off-centre. Moreover, there may be instances for which it is desirable to direct the dirt-laden fluid off-centre. For example, if the central region of the disc 40 were perforated, the dirt-laden fluid may be directed off-centre so as to avoid the region of the disc 40 where tangential speeds are slowest. As a result, a net gain in separation efficiency may be observed. By way of example, FIG. 14 illustrates an arrangement in which the dirt-laden fluid entering the chamber 36 is directed off-centre at the disc 40. Similar to the arrangement shown in FIG. 9, the inlet duct 21 is formed integrally with the side wall 31 of the container 20, and the bottom wall 32 is attached to the side wall 31 by a hinge 33 and catch (not shown). When the bottom wall 32 moves between the closed and opened positions, the position of the inlet duct 21 remains fixed. This then has the advantage that the container 20 is convenient to empty without the need to design a hinge and catch capable of withstanding the forces required to manoeuvre the cleaner head 4. Moreover, in contrast to the dirt separator 101 of FIG. 9, the inlet duct 21 is straight and thus pressure losses arising from the movement of the dirt-laden fluid through the inlet duct 21 are reduced.

In a more general sense, the dirt-laden fluid may be said to enter the chamber 36 along a flow axis 49. The flow axis 49 then intersects the disc 40 such that the dirt-laden fluid is directed at the disc 40. This then has the benefit that the dirt-laden fluid impacts the disc 40 shortly after entering the chamber 36. The disc 40 then imparts tangential forces to the dirt-laden fluid. The fluid is drawn through the holes 47 in the disc 40 whilst the dirt, owing to its greater inertia, moves radially outward and collects in the chamber 36. In the arrangements shown in FIGS. 3, 9, 10 and 11, the flow axis 49 intersects the centre of the disc 40, whilst in the arrangement shown in FIG. 14, the flow axis 49 intersects the disc 40 off-centre. Although there are advantages in having a flow axis 49 that intersects the centre of the disc 40, effective separation of dirt may nevertheless be achieved by having a flow axis 49 that intersects the disc 40 off-centre.

In each of the arrangements described above, the inlet duct 21 has a circular cross-section and thus the inlet 37 has a circular shape. Conceivably, the inlet duct 21 and the inlet 37 may have alternative shapes. Likewise, the shape of the disc 40 need not be circular. However, since the disc 40 rotates, it is not clear what advantages would be gained from having a non-circular disc. The perforated and non-perforated regions 45,46 of the disc 40 may also have different shapes. In particular, the non-perforated region 45 need not be circular or located at the centre of the disc 40. For example, where the inlet duct 21 is directed off-centre at the disc 40, the non-perforated region 45 may take the form of an annulus. In the above discussions, reference is sometimes made to the diameter of a particular element. Where that element has a non-circular shape, the diameter corresponds to the maximal width of the element. For example, if the inlet 37 were rectangular or square in shape, the diameter of the inlet 37 would correspond to the diagonal of the inlet 37. Alternatively, if the inlet were elliptical in shape, the diameter of the inlet 37 would correspond to the width of the inlet 37 along the major axis.

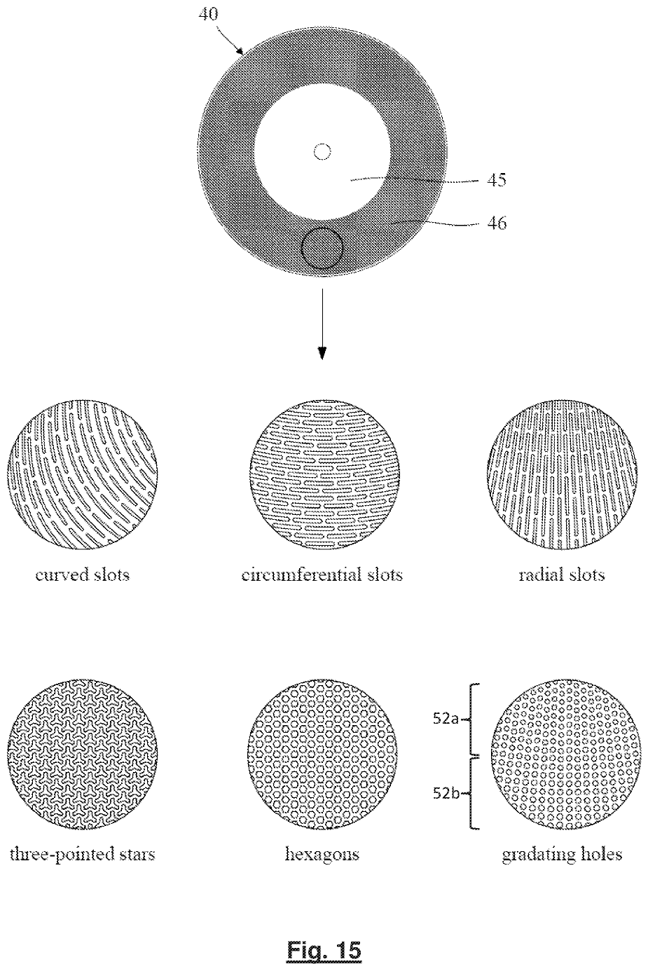

As can be seen in FIG. 4, the holes 47 in the disc 40 are circular in shape and have a constant size. However, as illustrated in FIG. 15, alternative shapes and varying sizes are possible. Of the six examples shown, the top three have holes which are elongate from the perspective of this figure (i.e. when viewed normal to the disc). They therefore define longitudinal axes which run within the plane of the disc. In the cases of the ‘curved slots’ and ‘circumferential slots’, these longitudinal axes are curved. The ‘circumferential slots’ are convex in the radial direction. The ‘curved slots’ are convex in the direction of rotation of the disc if the disc rotates clockwise from the perspective of FIG. 15, and are concave in the direction of rotation of the disc if the disc rotates anticlockwise from the perspective of FIG. 15.

FIG. 15 also includes an example of circular holes that increase in size as one moves radially outward, the ‘gradiating holes’. The perforated region 46 is divided into a first region 52a, and a second region 52b which is radially outward of the first region 52a. The holes of the first region 52a are smaller in diameter than the holes of the second region 52b, and accordingly the cross sectional area of each hole of the second region is larger than each hole of the first region. The holes are therefore smaller where the tangential speeds of the disc 40 are slower. This may then lead to improvements in separation efficiency without necessarily increasing the pressure drop across the dirt separator.

In this case, the land between the holes of the second region 52b is slightly wider than that between the holes of the first region 52a. This compensates for the increased open area provided by the larger holes, meaning that the first and second regions 52a, 52b have the same porosity. If the land between holes was the same width in both regions 52a, 52b, however, then the second region 52b would have a higher porosity than the first region 52a.

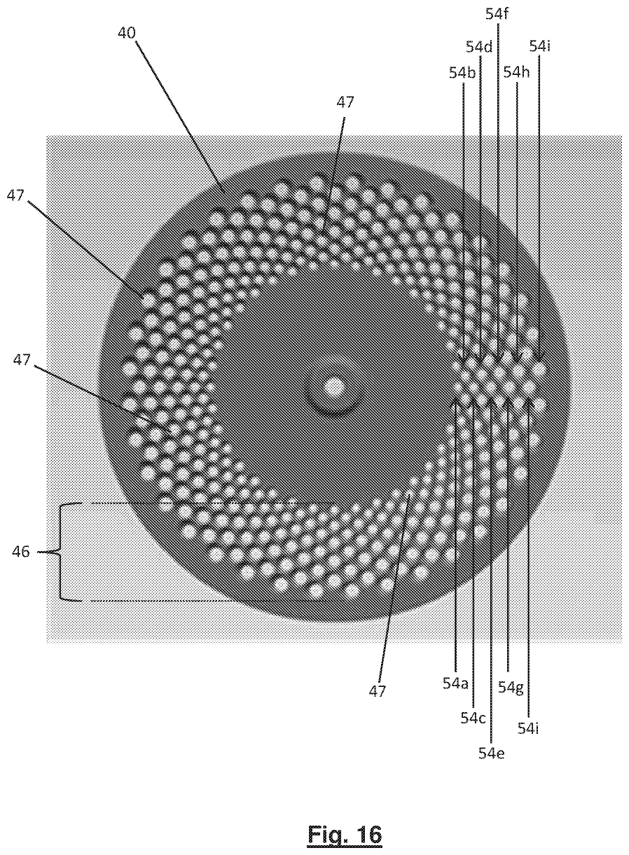

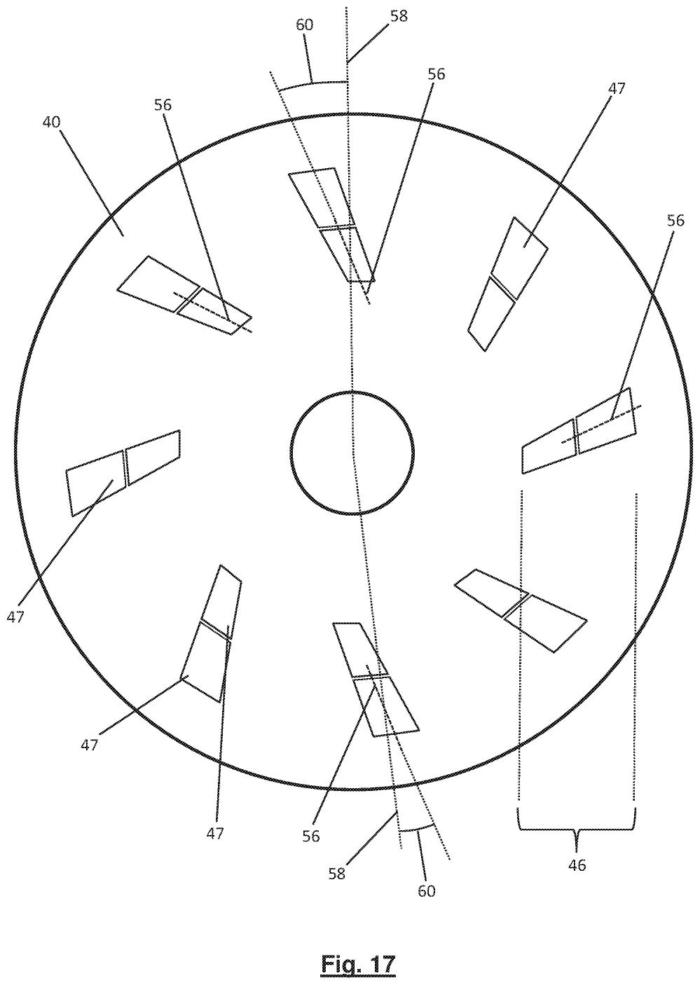

FIG. 16 shows another example of a disc 40 for use in a disc assembly 22 as described above. Like the previous example, this disc 40 has holes 47 that increase in cross sectional area across the radial extent of the perforated region 46. In this case the disc 40 has a set of 10 circumferential arrays 54a-54j of holes 47. The holes 47 increase in diameter, and thus cross sectional area, from the radially innermost array 54a to the outermost array 54j. In this case, the gradually increasing hole size across the radial extent of the perforated region 46 results in a corresponding gradual increase in porosity.

Although the change in hole size and porosity is gradual, for the avoidance of doubt the disc 40 can nonetheless be considered to have discrete regions in a similar fashion to the ‘gradating holes’ example of FIG. 15. For example, one may consider array 54a to occupy the first region and array 54b to occupy the second region (whereupon the difference in hole size, and porosity, would be relatively small). As another example, one may consider arrays 54a and 54b to occupy the first region and arrays 54i and 54j to occupy the second region (whereupon each hole of the second region would be around twice the diameter of each hole of the first region, meaning that each hole of the second region would have a cross sectional area around 175% that of each hole of the first region). As a further example, one may consider arrays 54a and 54b to occupy the first region, arrays 54d and 54e to occupy the second region, and arrays 54g-54i to occupy a third region which is radially outward of the second region (the hole size and porosity of the third region being higher than those of the second region).

FIG. 17 shows a schematic of another example of a disc 40 suitable for use in a disc assembly 22 such as those described above. In this case, as with the ‘curved slots’, ‘circumferential slots’ and ‘radial slots’ examples of FIG. 15, when viewed normal to the plane of the disc each hole 47 is elongate and defines a longitudinal axis 56 which runs within the plane of the disc 40.

In this case, the longitudinal axis 56 of each hole 47 is inclined relative to the associated radial direction 58 of the disc 40. As shown in FIG. 17 in respect of the lowermost and uppermost holes 47, in this example the longitudinal axis 56 of each hole 47 is inclined such that it defines an angle 60 of around 25 degrees with the associated radial direction 58. Further, the holes 47 are aligned such that their radially outer ends are positioned forward, in the direction of rotation of the disc (anticlockwise from the perspective of FIG. 17), of their radially inner ends. This allows the holes 47 to be positioned nearer normal to flow of air over the disc 40, as described in more detail later.

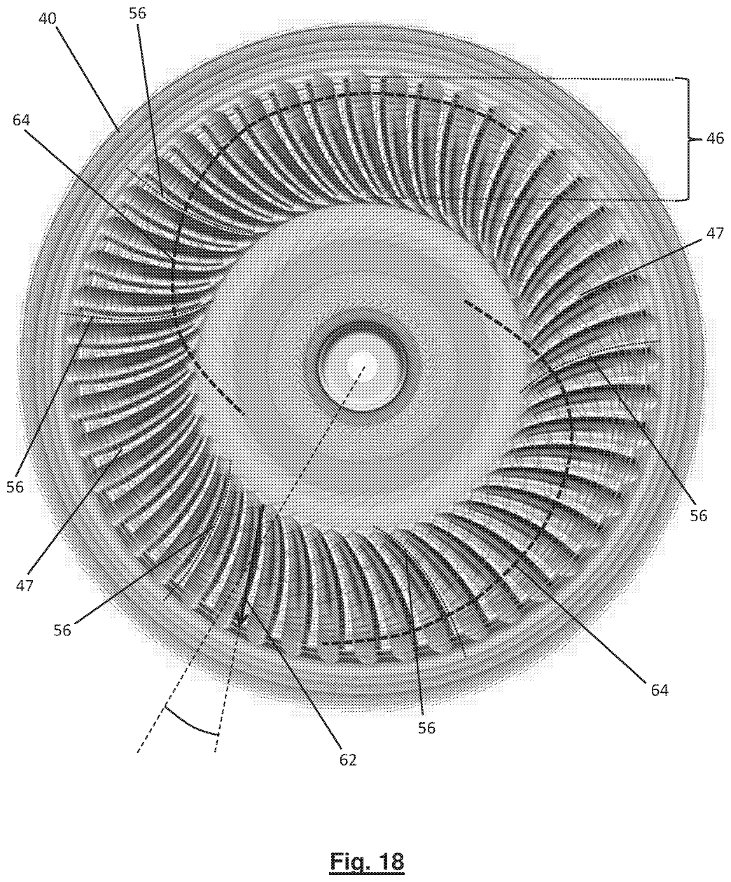

FIG. 18 shows another example of a disc 40. Like the disc of FIG. 17 the longitudinal axes 56 of the holes are inclined relative to the radial direction in that the path taken by each hole from one end to the other defines a vector 62 which is inclined relative to the associated radial direction 58. Also like the disc of FIG. 17, the disc 40 of FIG. 18 has holes 47 the radially outer ends of which are forward, in the direction of rotation of the disc 40 (anticlockwise from the perspective of FIG. 18), from their radially inner ends.

Whereas the holes 47 of the disc 40 of FIG. 17 each extend over around half the radial extent of the perforated region 46 (i.e. they extend over around half the radial extent of the portion of the disc 40 over which the holes are provided), in the disc of FIG. 18 each hole 47 extends over the entire radial extent of the perforated region 46. The disc 40 of FIG. 18 also differs from that of FIG. 17 in that the longitudinal axes 56 of the holes are curved, in similar fashion to the ‘curved slots’ and ‘circumferential slots’ of FIG. 15. They are convex in the direction of rotation of the disc. In this case the radius of curvature of the centrelines is slightly smaller than the radius of the disc—the radius of the disc is 43 mm and the radius of curvature of longitudinal axes 56 is 41 mm. The radius of curvature of the disc is therefore around 95% of the radius of the disc.

The inclination of the holes 47 relative to the radial direction, and their convexity in the direction of rotation of the disc 40, means that each hole can be positioned normal to the path of fluid across the disc. Such air paths are shown in FIG. 18, along with two which have been traced with thicker lines 64. The flow lines have a component in the radial direction due to the air flowing radially outwards over the disc, and have a component in the tangential direction due to the rotation of the disc. The tangential component becomes more dominant as the flow moves radially outwards due to the increasing tangential speed of parts of the disc as radial position increases. Accordingly, the path lines 64 take the form of a gradually tightening outward spiral. The inclination of the holes 47 positions them generally normal to the average swirl angle of the path lines 64, and their arcuate nature allows the holes 47 to remain substantially exactly normal to the path lines 64 as their swirl angle changes.

As with the disc 40 of FIG. 16, the porosity of the disc increases gradually across the radial extent of the perforated region 46, therefore the position of first and second (or first, second and third) regions can be assigned in a number of ways. For instance, the first region may be considered to be only the innermost part of the perforated region 46 and the second region may be considered to be only the outermost part. The porosity of the innermost part of the perforated region 46 is around 12% and the porosity of the outermost part is around 20%, therefore if the first and second regions were defined in this way then the second region would have a porosity around 65% larger than that of the first region.

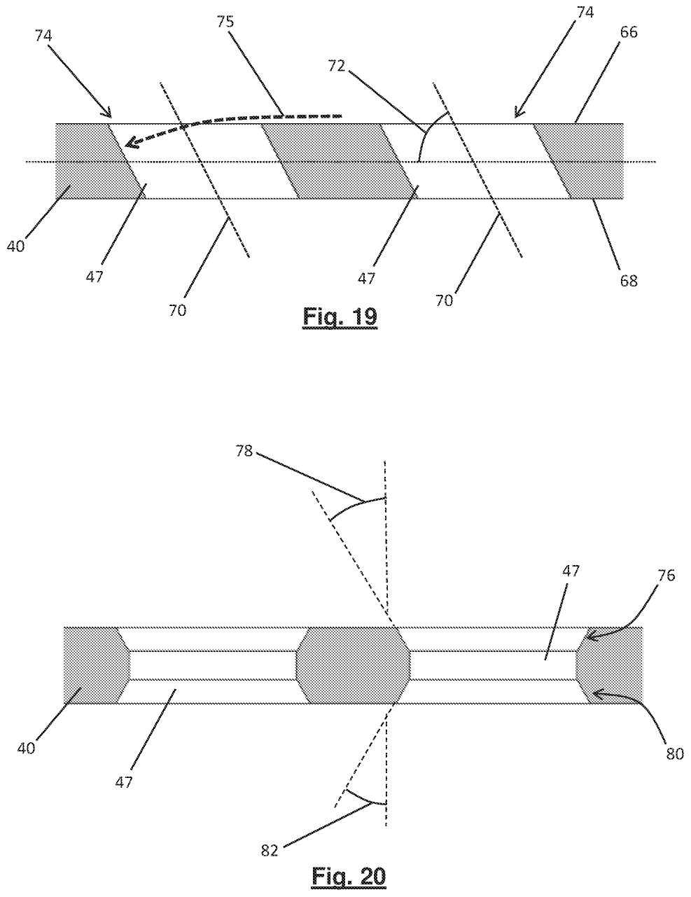

FIG. 19 shows part of another disc 40, in cross section, viewed in the radial direction. From the perspective of FIG. 19, rotation of the disc 40 corresponds to movement of the visible portion towards the right. The path of each hole 47 through the disc 40, from an upstream face 66 of the disc to a downstream face 68, defines a centreline 70. The centreline 70 of each hole 47 is non-perpendicular to the disc 40. More particularly, it is inclined such that the centreline 70 intersects the upstream face 66 at a point which is behind, in the direction of rotation of the disc 40 (i.e. further to the left from the perspective of FIG. 19), the point at which the centreline 70 intersects the downstream face 68. In this case the centreline 70 of each hole 47 defines an angle 72 of around 60 degrees with the plane of the disc.

The holes 47 being inclined ‘backwards’ in this way can improve the separation performance of the disc 40. As the disc 40 rotates, air entering each hole 47 tends to impact the rearward portion of the mouth 74 of the hole, as denoted by path line 75. The rearward portion of the mouth 74 being inclined backwards, due to the inclination of the centreline 70, tends to cause dirt to bounce out of the hole 47 rather than travelling through it. In contrast, if the holes 47 were angled ‘forwards’ then their mouths would act as scoops, tending to retain dirt particles in the flow of air through the disc.

Part of another disk 40 is shown in FIG. 20, from the same perspective as FIG. 19. Each hole 47 of this disc 40 has a tapered portion 76 which narrows in the downstream direction. In this case the tapered portion 76 takes the form of a frusto-conical chamfer surface positioned at the intersection between the hole 47 and the upstream face 66. The taper angle 78 of the chamfer surface is around 30 degrees. Each hole 47 also has a reverse-tapered portion 80 positioned downstream of the tapered portion 76, which widens in the downstream direction. The taper angle 82 of the reverse-tapered portion is also around 30 degrees.

The tapered portion 76 provides similar functionality as described above in relation to the mouths 74 of the holes 47 of FIG. 19—air entering the hole 47 tends to impact the inclined surface provided by the tapered portion 76, providing dirt with further opportunity to ricochet out of the hole 47 rather than passing through it. In contrast, if the hole 47 intersected the upstream face 66 at a 90 degree corner, any dirt entering the mouth of the hole would likely be retained therein and pass through the disc. The reverse-tapered portion 80 acts as a diffuser, slowing the flow through the hole 47 (after it was accelerated in the tapered portion 76) so that it exits the disc 40 more smoothly.

Another disc the holes of which have tapered portions is shown in FIG. 21. In this case the entire of each hole 47 constitutes the tapered portion 76—each hole tapers along its entire length through the disc 40. In this case each hole 47 intersects the upstream face 66 of the disc 70 at a fillet surface 84, which can smooth the flow of air over the upstream face 66 and into the hole 47.

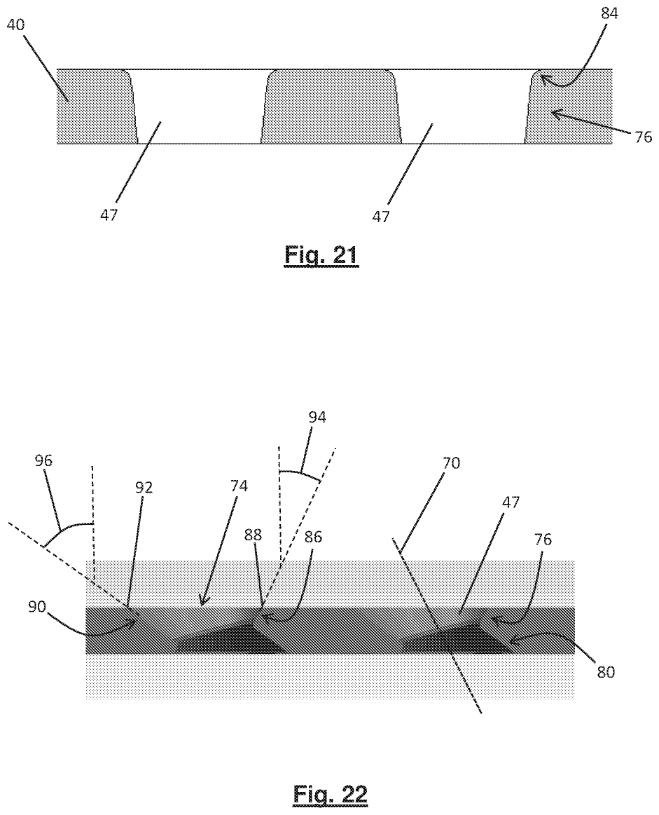

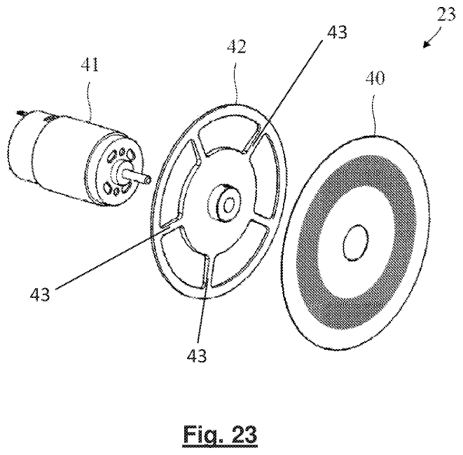

A further disc 40 is shown in FIG. 22. Each hole 47 of this disc is in essence a combination of the holes of FIGS. 19 and 20 in that it has an inclined centreline 70, a tapered portion 76 in the form of a chamfer surface, and a reverse-tapered portion 80. In this case, however, the chamfer surface is part of an oblique cone rather than a circular cone—different parts of the chamfer surface have different taper angles. A forward part 86 of the tapered portion 76, which intersects a leading edge 88 of the mouth 74 (in the direction of rotation of the disc), is steeper than a rearward part 90 of the tapered portion, which intersects a trailing edge 92 of the mouth 74. The taper angle 94 of the forward part 86 is around 30 degrees and the taper angle 96 of the rearward part 90 is around 55 degrees.

The thickness of the disc 40 is an important factor in the design of separators such as those described above. A thicker disc 40 is naturally stiffer and less susceptible to damage. Further, where features such as those discussed in relation to FIGS. 19-22 are provided, a thicker disc can allow the effect of those features to be enhanced. However, a thicker disc 40 is not without its disadvantages. As the disc 40 rotates, the wall of each hole 47 pushes the fluid moving through it. As a result, the disc 40 imparts swirl to the cleansed fluid moving through the disc 40. As the thickness of the disc 40 increases, the swirl imparted to the cleansed fluid increases. This then has two adverse consequences. First, the pressure drop associated with the dirt separator 10 increases. Second, the power required to drive the disc 40 at a particular speed increases. A further difficulty in having a thicker disc 40 is that the manufacturing time and cost are likely to increase. An optimum compromise for domestic vacuum cleaners may be in the region of 2-4 mm. Each of the discs illustrated in FIGS. 19-22 are 3 mm thick.

In the arrangements described above, the disc assembly 22 comprises a disc 40 directly attached to a shaft of an electric motor 41. Conceivably, the disc 40 may be attached indirectly to the electric motor, e.g. by means of a gearbox or drive dog. Furthermore, the disc assembly 22 may comprise a carrier to which the disc 40 is attached. By way of example, FIG. 16 illustrates a disc assembly 23 having a carrier 42. The carrier 42 may be used to increase the stiffness of the disc 40. As a result, a thinner disc 40 or a disc 40 having a larger diameter and/or a larger total open area may be used. The carrier 42 may also be used to form the seal between the disc assembly 23 and the container 20. In this regard, whilst a contact seal between the disc 40 and the top wall 30 has thus far been described, alternative types of seal may equally be employed, e.g. labyrinth seal or fluid seal. The carrier 42 may also be used to obstruct the central region of a wholly perforated disc. In the example shown in FIG. 16, the carrier 42 comprises a central hub, connected to a rim by radial spokes 43. Fluid then moves through the carrier 42 via the apertures between adjacent spokes 43.

Each of the disc assemblies 22,23 described above comprises an electric motor 41 for driving the disc 40. Conceivably, the disc assembly 22,23 may comprise alternative means for driving the disc 40. For example, the disc 40 may be driven by the vacuum motor 12. This arrangement is particularly viable with the layout shown in FIG. 1, in which the vacuum motor 12 rotates about an axis that is coincident with the rotational axis 48 of the disc 40. Alternatively, the disc assembly 22,23 may comprise a turbine powered by the flow of fluid moving through the disc assembly 22,23. A turbine is generally cheaper than an electric motor, but the speed of the turbine, and thus the speed of the disc 40, depends on the flow rate of fluid moving through the turbine. As a result, high separation efficiencies can be difficult to achieve at low flow rates. Additionally, if dirt were to clog any of the holes 47 in the disc 40, the open area of the disc 40 would decrease, thereby restricting the flow of fluid to the turbine. As a result, the speed of the disc 40 would decrease and thus the likelihood of clogging would increase. A runway effect then arises in which the disc 40 becomes increasingly slower as it clogs, and the disc 40 becomes increasingly clogged as it slows. Furthermore, if the suction opening in the cleaner head 4 were to become momentarily obstructed, the speed of the disc 40 would decrease significantly. Dirt may then build up significantly on the disc 40. When the obstruction is subsequently removed, the dirt may restrict the open area of the disc 40 to such an extent that the turbine is unable to drive the disc 40 at sufficient speed to throw off the dirt. An electric motor, whilst generally more expensive, has the advantage that the speed of the disc 40 is relatively insensitive to flow rates or fluid speeds. As a result, high separation efficiencies may be achieved at low flow rates and low fluid speeds. Additionally, the disc 40 is less likely to clog with dirt. A further advantage of using an electric motor is that it requires less electrical power. That is to say that, for a given flow rate and disc speed, the electrical power drawn by the electric motor 41 is less than the additional electrical power drawn by the vacuum motor 12 in order to drive the turbine.

The dirt separator 10 has thus far been described as forming part of a handheld unit 2 that may be used as a standalone cleaner or may be attached to a cleaner head 4 via an elongate tube 3 for use as a stick cleaner 1. The provision of a disc assembly in a handheld unit is by no means intuitive. Although the provision of a rotating disc within a dirt separator of a vacuum cleaner is known, there is an existing prejudice that the dirt separator must include a cyclone chamber to separate the dirt from the fluid. As a result, the overall size of the dirt separator is relatively large and is unsuitable for use in a handheld unit. With the dirt separator described herein, effective separation may be achieved in a relatively compact manner. As a result, the dirt separator is particularly well suited for use in a handheld unit.

The weight of a handheld unit is clearly an important consideration in its design. The inclusion of an electric motor in addition to the vacuum motor is not therefore an obvious design choice. Additionally, where the handheld unit is battery powered, one might reasonably assume that the power consumed by the electric motor would shorten the runtime of the vacuum cleaner. However, by using an electric motor to drive the disc, relatively high separation efficiencies may be achieved for a relatively modest drop in pressure. Consequently, in comparison to a conventional handheld cleaner, the same cleaning performance may be achieved using a less powerful vacuum motor. A smaller vacuum motor may therefore be used that consumes less electrical power. As a result, a net reduction in weight and/or power consumption may be possible.

Although the dirt separator according to various aspects described herein is particularly well suited for use in a handheld vacuum cleaner, it will be appreciated that the dirt separator may equally be used in alternative types of vacuum cleaner, such as an upright, canister or robotic vacuum cleaner.

It will be appreciated that numerous modifications to the above described embodiments may be made without departing from the scope of invention as defined in the appended claims. For instance, although in the above embodiments the holes in the disc are made up of a series of discrete surfaces, it is to be understood that in other embodiments the sides of the holes may take the form of a continuously-contoured curved surface. For example, in a modification of the disc of FIG. 20, the holes may be formed by a continuous flowing curve which narrows and then expands again in the downstream direction so as to give the hole an hourglass-like shape.

1. A dirt separator for a vacuum cleaner, the dirt separator comprising:
a chamber having an inlet through which dirt-laden fluid enters the chamber and an outlet through which cleansed fluid exits the chamber; and
a disc located at the outlet, the disc being arranged to rotate about a rotational axis, and comprising holes running from an upstream face to a downstream face through which the cleansed fluid passes,
wherein:
each hole has a tapered portion which narrows from an upstream end to a downstream end thereof.

2. The dirt separator of claim 1, wherein the tapered portion of each hole includes a chamfer surface positioned at the intersection between the hole and the upstream face of the disc.

3. The dirt separator of claim 1, wherein the tapered portion of each hole includes a fillet surface.

4. The dirt separator of claim 1, wherein each hole includes a reverse-tapered portion downstream of the tapered portion, the reverse-tapered portion widening from an upstream end to a downstream end thereof.

5. The dirt separator of claim 1, wherein:
the disc is configured to rotate in a predetermined direction about the rotational axis;
each hole intersects the upstream face of the edge at a mouth which has a leading edge and a trailing edge; and
a forward part of the tapered portion, which is at or adjacent the leading edge, is steeper than a rearward part of the tapered portion, which is at or adjacent the trailing edge.

6. The dirt separator of claim 1, wherein:
the holes are distributed over at least first and second regions of the disc, the second region being radially outward of the first region; and
the porosity of the second region is higher than the porosity of the first region.

7. The dirt separator claim 1, wherein when viewed normal to the disc, each hole is elongate and defines a longitudinal axis which runs within the plane of the disc.

8. The dirt separator of claim 6, wherein each hole extends across substantially the entire radial extent of the disc over which the holes are provided.

9. The dirt separator of claim 7, wherein the longitudinal axis of each hole is inclined relative to the radial direction of the disc.

10. The dirt separator of claim 7, wherein the longitudinal axis of each hole is curved.

11. The dirt separator of claim 1, wherein each hole has a tapered portion which narrows from an upstream end to a downstream end thereof.

12. The dirt separator of claim 1, wherein:
the disc is arranged to rotate in a predetermined direction about the rotational axis; and
when viewed along the radial direction of the disc, the path of each hole through the thickness of the disc defines a centreline, the centreline being inclined such that it is non-perpendicular to the disc

13. The dirt separator of claim 12, wherein the centreline of each hole is inclined such that it intersects the upstream face of the disc at a point which is behind, in the direction of rotation of the disc, the point at which the centreline intersects the downstream face of the disc.

14. A vacuum cleaner comprising a dirt separator that comprises:
a chamber having an inlet through which dirt-laden fluid enters the chamber and an outlet through which cleansed fluid exits the chamber; and
a disc located at the outlet, the disc being arranged to rotate about a rotational axis, and comprising holes running from an upstream face to a downstream face through which the cleansed fluid passes,
wherein:
each hole has a tapered portion which narrows from an upstream end to a downstream end thereof.

15. The vacuum cleaner of claim 14, wherein the vacuum cleaner is a stick vacuum cleaner comprising a handheld unit attached to a cleaner head by an elongate tube, the handheld unit comprising the dirt separator, and the elongate tube extending along an axis parallel to the rotational axis.
